(19) United States
(12) Patent Application Publication
(10) Pub. No.: US 2006/0167971 A1
(43) Pub. Date: Jul. 27, 2006

(54) System and method for collecting and disseminating human-observable data

(76) Inventor: Sheldon Breiner, Portola Valley, CA (US)

Correspondence Address: NIXON PEABODY, LLP, 401 9TH STREET, NW, SUITE 900, WASHINGTON, DC, 20004-2128, US

(21) Appl. No.: 11/322,051

(22) Filed: Dec. 29, 2005

Related U.S. Application Data
(60) Provisional application No. 60/640,344, filed on Dec. 30, 2004.

(51) Int. Cl. G06F 15/16

(52) U.S. Cl. 709/202

(57) ABSTRACT

A system and method are disclosed for creating a network of persons, efficiently connected to a computer through a location-aware mobile phone network, to enable them to perform the duties of sensing agents to collect and deliver to a computer server human-observable data of commercial or public value across a large area. The data collection process tightly integrates the agents, using the phones as the primary interface to the server, to program the actions and objective results of the agent-observers, effectively making them extensions of software programs resident on a computer server. Requests, via Internet browser-based interfaces from clients of such data, are translated by software into specific instructions to appropriate agents in the network specifying such parameters as observations sought, sample densities, locations, frequencies of observations and other such critical parameters. Reporting and delivery of analyzed results to the client is automatic, modulated as necessary by other database information.

### CROSS REFERENCE TO RELATED APPLICATION

This application clams the benefit of U.S. provisional application Ser. No. 60/640,344 filed Dec. 30, 2004, which application is incorporated by reference herein.

### FIELD OF THE INVENTION

The invention is directed to a system and method for collecting data from a plurality of agents and disseminating the data as information to a client. More particularly, the invention is directed to a system and method for collecting data from a network of persons, efficiently connected to a computer through a location-aware wireless communication network, to enable them to perform the duties of sensing agents to collect and deliver to a computer server human-observable data of commercial or public value across a large area.

### BACKGROUND OF THE INVENTION

Data sampling of human activities is used to influence a wide array of commercial, environmental, political, and human affairs. Most data used for such purposes is accessed from databases where the data is acquired by some automatic process, though, some data are also gathered by manual observation. In all cases there is a cost for the collection of these data and it is this cost and complexity that often determines how, or if, such data will be used. There is also the matter of how detailed the data can be with respect to the variables of interest, such as how often and how densely it is sampled, i.e., the granularity in time and space of the sampling. In addition, collection of data where there is no automatic method of collection might require persons to make observations, to report them to a central repository where the data are analyzed, and then to deliver the data to the intended users.

Collecting information by persons from far flung sources through, observations, interviews and non-automated data capture is, generally, a slow, expensive process. Similarly, analysis, presentation and dissemination of such data to users of such information can require a considerable amount of work and, depending upon methods employed, can also be cumbersome and costly. For these reasons, human-observed data collection is not a commonly employed basis for gathering survey data not already available online or in existing files.

There is a wide range of modes and purposes of data collection that could, if practical, utilize human sensing, observation and reporting. A few examples of such information collection are competitive analyses, market surveys, market intelligence, clinical trials, consumer sampling, online auction bid/sale analysis, political polls, security monitoring, environmental surveys, food and public safety monitoring, construction inspection, public dining and entertainment ratings, conditions of public spaces and roads, sampling of wildlife, monitoring of certain media for royalty-bearing and content purposes and, government compliance monitoring, to name a few.

The procedures for human-observable data collection has, for most in the field, been accomplished by such diverse means as telephone surveys, Internet opinion surveys, taking notes in the field, dictating notes into a machine, digital sampling of media, videotaping, telephonic or wired opt-in participatory surveys, as in ACNielsen® surveys, entry into a hand-held computer or PDA, still camera photos or physical sample collection.

On-line surveys are available on the Internet from firms such as Questionpro and SyncSurvey both of which companies make available market research for clients to set up their own wireless survey programs.

U.S. Pat. No. 6,360,172 describes a system for monitoring weather phenomena using wireless devices and U.S. patent application 20020103694 describes a system for collecting poll data via wireless communications devices, which descriptions of the wireless devices are incorporated by reference herein.

However, the costs for data collection are currently so high that only organizations with very important reasons and large budgets where the outcome is important, can afford to commission and pay for such human-observable data surveys. Moreover, the time that it takes for data collection and the efforts to acquire the data relegate such data collection to one-time, seldom-conducted or high-value survey objectives. In those cases, where the nature of the data changes rapidly, the one-instance collection either has little meaning or the relevant periodic data collection is not practical. Consequently, the user is prevented from obtaining the desired data and the benefits of its consequential analysis.

The cost for such analyses is usually so high that the users have correspondingly high expectations for the nature of the reports summarizing these studies. A large industry has evolved to deliver such studies, exemplified by well-established companies such as Booz Allen Hamilton, McKinsey & Company and Accenture, to name a few. They deliver large, expensive, albeit comprehensive reports by virtue of the industry-standard complex procedures for data collection and analysis and the concomitant costs. This standard of data collection and analysis effectively shuts out smaller clients less able to afford such services.

Often, the research conducted is not sufficiently timely or the sampling is inappropriate for making certain organization-critical decisions. In addition, the costs to achieve these goals may be too high to achieve these goals.

It would be desirable to have a system that is not subject to these limitations. Such a system might allow for variable density sampling and frequent periodic sampling, which might make possible iterative market research by obtaining immediate responses to offerings, having time to make fine-tuning changes in the products, and ability-to obtain instant market re-sampling, all with sufficient response time and resolution in time and place, in a manner that might be considered dynamic, rather than static or after the fact.

Furthermore in such a system, data collection could even be conducted with sufficiently dense sampling or, in the time domain, over sufficiently short time intervals, or be conducted regularly at a data granularity that satisfies many market needs previously unmet. For example, if the data were analyzed with sufficient density in time or space allowing analysis of the rate of change, i.e., the first or second derivative of the variables, results might provide fundamentally greater significance to the users, hence, better results for the market as a whole.

Because of the limitations of human-observed market research, whether it be used for commercial benefit or for governmental, medical, environmental or other such widely-applicable surveys, there is a need for a more efficient system and method for conducting human-observable data sampling and reporting than those presently available in the prior art.

### SUMMARY OF THE INVENTION

The present invention overcomes these disadvantages of the prior art by providing a system and method for collecting data from a plurality of agents and disseminating the data as information to a client.

The system includes a computer server having software for accepting requests received via Internet browser-based interfaces from the client to collect the data generated by data-collecting agents and for receiving the data from the agents at a remote source.

Each of the plurality of data collecting agents is equipped with one or more mobile phones, personal digital assistants (PDA's), other wireless application protocol (WAP) products, e.g., WAP-enabled cellular phones (cell phones), or other wireless communication devices and data collection devices used as subsystems interfaced to the cell phones and networked to the computer server for each of the plurality of agents for downloading instructions to carry out the client's request. The wireless communication devices are also used by the agents to upload the collected data to the computer server. Preferably, the cell phone or other wireless device is equipped with location capability, for example, use of GPS, triangulation of mobile towers or other devices for time, date and location stamp.

An operating means is installed for analyzing and converting the data received from each of the agents by the server into information for disseminating to the client. This operating means includes system software for converting the raw field data from each of the agents into meaningful information in the form of textual material as well as graphics, charts and other visual display of the results of the data collection. The information is compiled into reports for uploading to the Internet, which allows for the reports to be easily accessible by the client.

Briefly the method of the present invention includes the steps of:

(a) receiving from the client a request to collect the data generated by each of the plurality of agents via server interfaces;

(b) downloading instructions to carry out the client's request by each of the agents via cell phones or other wireless communication devices interfaced to the computer server;

(c) uploading the data collected by each of the agents via the cell phones to the server; and

(d) analyzing and converting the data received from the agents by the server into information for disseminating to the client.

### BRIEF DESCRIPTION OF THE DRAWINGS

Further features and advantages will become apparent from the following and more particular description of various embodiments of the present invention, as illustrated in the accompanying drawings in which:

FIG. 1 is a simplified diagram of the system of the present invention in which a plurality of agents initially interacts with the network and downloads the application that qualifies each of the agents and enables each of the agents to operate within the network;

FIG. 2 is a flowchart of the process of the present invention by which each of the agents downloads and initializes the enabling application to be placed on the agent database;

FIG. 3 illustrates the interaction, via the Internet, of the client with the computer server in order to sign up and specify the objectives and specifications of the information sought from the network;

FIG. 4 is a generalized diagram showing the overall system, key components of the network which allow actions by the client to generate commands for agent response;

FIG. 5 illustrates through a flowchart showing how the client starts the process resulting in instructions to each agent for the desired information; and

FIG. 6 is the flowchart illustrating the process from the perspective of one agent's actions to gather the client-specified information, subsequent automatic integration of all agent data, and generation of a report for uploading to the Internet for access by the client.

### DETAILED DESCRIPTION OF VARIOUS EMBODIMENTS OF THE PRESENT INVENTION

The figures depict procedures and currently available technology to empower unskilled agents as the sensing elements of a system to collect information valuable to various users, herein called clients. The agents at one end and the clients at the other are supported and connected through cell phones, wireless and wired networks and computers to deliver this information, rapidly, inexpensively and pervasively.

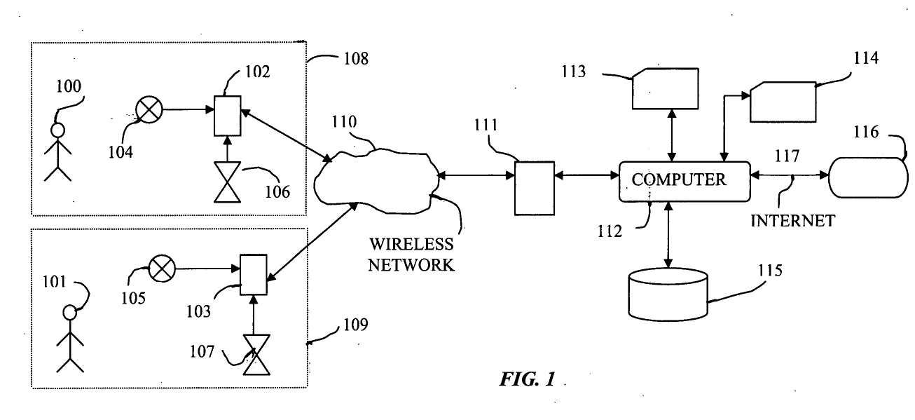

FIG. 1 illustrates the components of the system of one embodiment of the present invention in which a plurality of agents, equipped with wireless communication devices, are incorporated into the network. Agents 100 and 101 use cell phones or other such wireless devices 102 and 103, equipped each with GPS or similar location-aware modules 104 and 105, respectively. Agents may also utilize various ancillary input devices to assist in efficient data collection. For example, devices 106 and 107 may include bar code scanners, RFID tags, wireless or infrared-linked devices using, for example, Bluetooth, WiFi or WiMAX linked to the agent's cell phone. In each case in FIG. 1, the agent's domain, blocks 108 and 109, include the agent and these wireless devices and data input devices.

The cell phones or wireless communication devices communicate through wireless network 110 to wireless communications provider interface 111. Information to and from the cell phones and their operating agents goes through computer server 112, a powerful central computer serving the entire network of agents 100 and 101 and client 116, the latter through the Internet 117. The general operations of computer server 112 are controlled from software 113.

To initiate naive agents who have not yet connected to server 112, the agents call a specific number, perhaps known by the agents through the Internet or the media. The agents are instructed via stored voice mail commands to download application software 114 onto cell phones 102 and 103, and, when completed successfully, agents'profiles will be stored on the agent database 115.

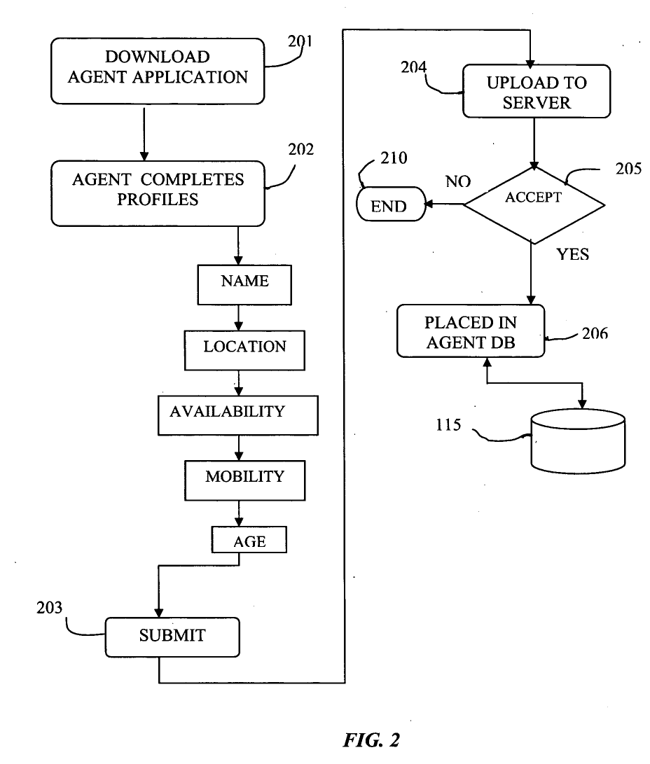

Referring now to the flowchart in FIG. 2 in which during download phase, a cell phone-compliant enabling application is downloaded (block 201) onto cell phone 102 to enable the cell phone to interact specifically with the network and, in particular, to be responsive to commands and inquiries from the central computer server 112. The downloaded enabling application also has an initialization procedure by which the agent's profile is completed and collected (block 202) to assist in assigning tasks which are appropriate to the specific agent. The information includes the agent's name, address, location, time availability, mobility, cell phone specifications, and the agent's willingness to acquire ancillary devices for assisting data collection, education level, age and motivation for such a job. This enabling application also assesses the agent's ability to perform simple tasks, to assess facility with cell phones, and natural abilities for observation and reporting. Finally, the agent completes a form enabling the agent to receive compensation, via cell phone-connected payment services, for the work performed. Subsequent to this initial download and after a period of acknowledged work, the agent will download another, more advanced application, not shown here to further profile the agent's skills and work product.

Once completed, the candidate agent submits (block 203) the agent information which is then uploaded (block 204) to computer server 112. The agent's profile is then compared with established criteria (block 205) and, if a certain threshold is exceeded, the agent is placed (block 206) in the agent database 115. If the established criteria are not exceeded, the agent is rejected and the process ends (block 210).

The steps of the process are performed with many such agents in order to establish a widespread agent base whose individual profiles and collective abilities represent an all-encompassing observer force capable of delivering the kind of information desired by a widespread set of clients.

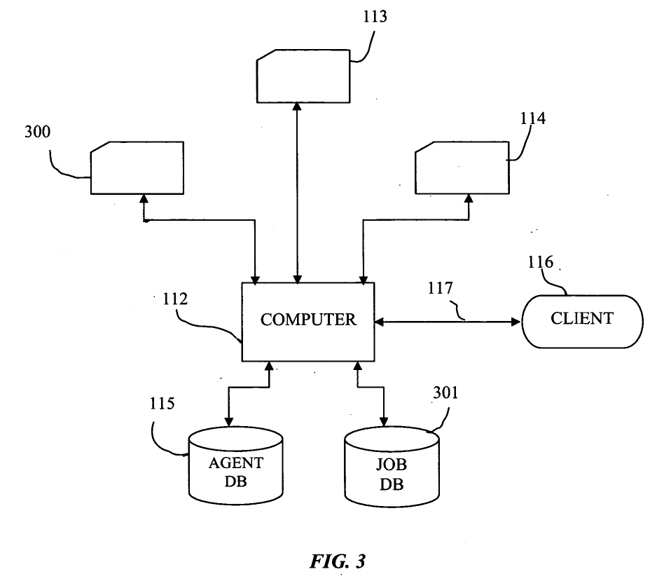

Client 116 in FIG. 3 drives the process accessing the network through the Internet 117 and the World Wide Web though a window of a browser such as Netscape Navigator® and Microsoft Internet Explorer®. Within that browser, the client accesses the computer server 112, controlled by system software 113 and application software 300.

Client 116 accesses computer 112 to begin the process of specifying the data necessary to satisfy client objectives. Among such data criteria would be generally where, when and how often the data is to be observed, the breadth of coverage, the specific nature of the data and other such parameters important to both the client and to the need to translate these general objectives to specific agent assignments. Furthermore, knowledge of the analytical processes to be used, such as relational database analysis, GIS mapping systems, statistical analysis, data mining and factor analysis, among others, will guide the design of the parameters of the data observations, given the objectives of the client. Such techniques are known to any skilled in the art of data analysis. Details of the sampling and client job requirements will be derived using software 300 and computer server 112.

The costs and contractual commitments for acquisition of such information by the network of agents are also computed or otherwise derived in software 300. The specifications of the observed assignment, or job, and all future results of that job are stored in client job database 301. Server 112 is controlled by system software 113 to perform the computations. Agents' application software 114 matches the skills of the agents taken from the profiles of the agents stored in agent database 115 with those necessary to perform the assigned tasks of collecting information.

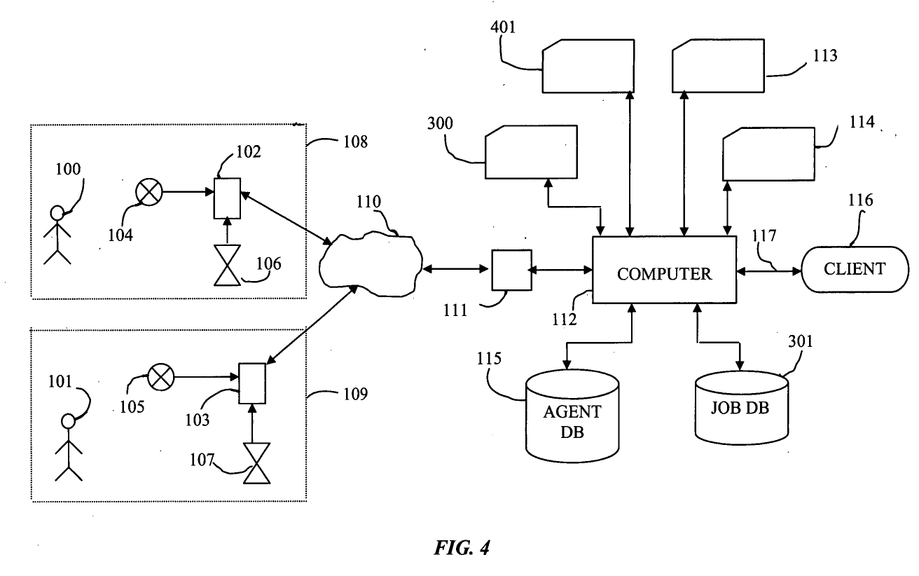

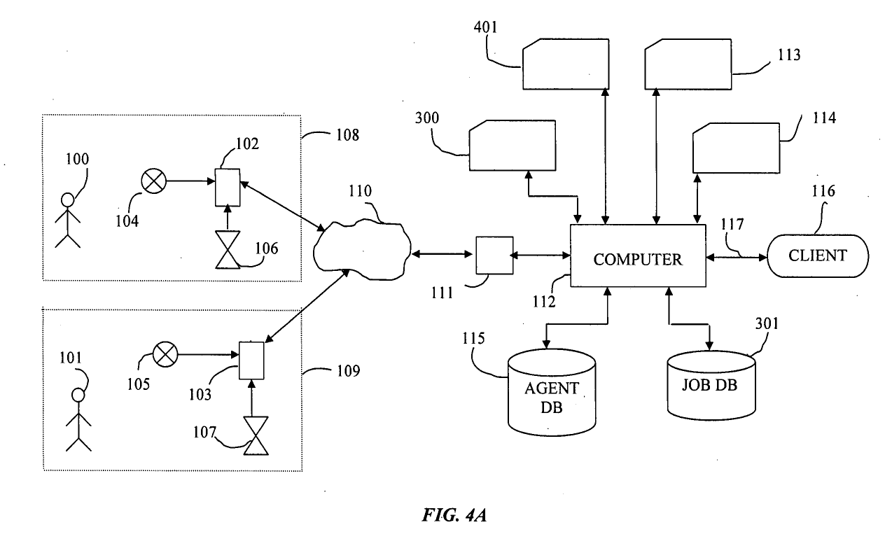

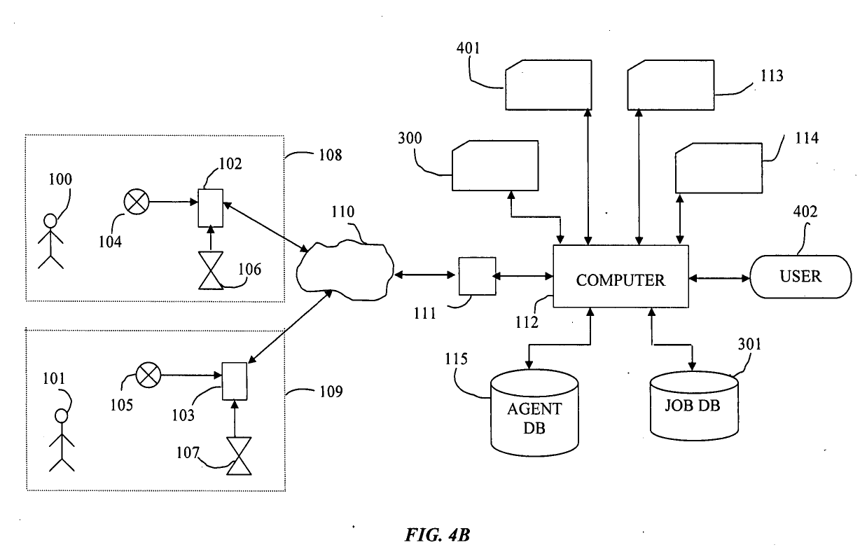

FIG. 4 shows all of the components of the system of the present invention including both the client and the agents and their connections in which client 116 is in communication with computer server 112 via the Internet 117. System software 113, agent profile software 114, job assignment software 300 for agent commands and report generator software 401 are all processed in the computer server 112. Agent profiles are stored in agent database 115 and the client job data are stored in the job database 301. At the observer data-gathering end of this network are the agents shown here as 100 and 101 using cell phones 102 and 103 with GPS location or equivalent modules 104 and 105 and data input devices 106 and 107. The agents'cell phones are connected via a wireless wide area network 110 and wireless communications center at a wireless service provider 111. Client 116 requests drive the entire process with requests submitted via a browser at the client site.

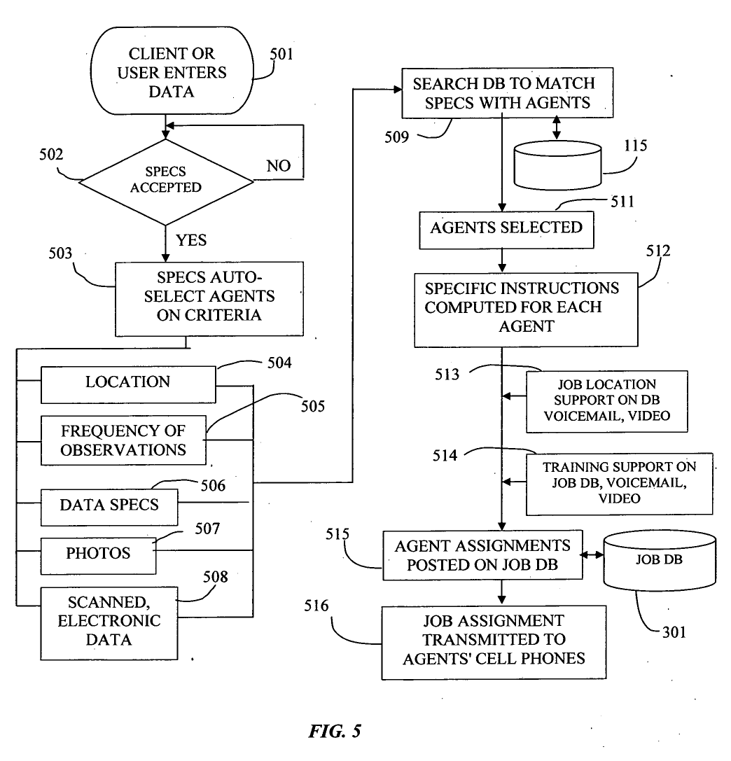

FIG. 5 illustrates the flow of information and the steps in setting up an assignment. This process starts with client 116 engaging the network and entering specifications of the assignment (block 501) via a browser. The client, using a wizard-type of interaction, completes the forms necessary to develop the job specifications. To insure that the assignment fits what is possible and fits the amounts quoted in the browser, the method has a feedback stage (block 502) to guide the client-derived, client-driven process. If the client enters specification data not compatible with the method of the present invention, the client receives a negative message. If the data is compatible, the client receives a positive message. After the positive message is received by the client, software 300 shown in FIG. 4 controls a step of the process shown in FIG. 5 as the specification auto-select agents criteria step (block 503). This step is constrained by the client specifications. For example, the specifications may include location (block 504), frequency of observations (block 505), data specifications (block 506), photographs (block 507) and scanned and other data (block 508) to make a determination of what agents are to be deployed for this defined task and consequently assigned job. The search of the database to match the specification with agents step (block 509), results in agents being selected step (block 511) relative to their location, availability, and other criteria from the information in agent database 115. The search results are determined in this step by algorithms in software 300.

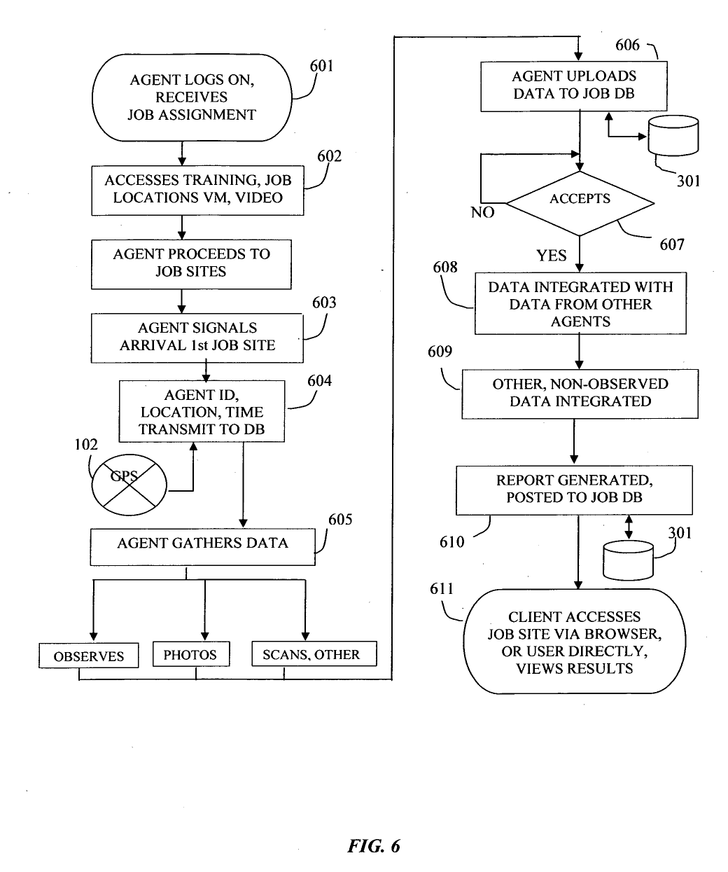

Once the agent network for this job is determined, commands necessary to accomplish the client job, per specifications to each and every agent, are computed into the specific instructions for each agent step (block 512). Thus, driven by contractual requests from a client for an observation assignment, derived commands are formulated automatically to specific agents. This step of the process is central to this invention and its consequences in the form of actions by agents are shown in the flowchart shown in FIG. 6. It is this specific agent instructions step (block 512) that automatically generates orders to agents. These orders may include directing where the agents are to go, when to go, how often, what to observe, how to report, whether to take pictures, whether to scan using RFID or barcode or photography or use other electronically-connected sampling aids and many other parameters of any data sampling assignment. For this reason, the process of the present invention is very efficient, low-cost, inherently scalable and productive.

Simultaneous to specific instruction step (block 512), voice mail from voice synthesis software, including perhaps frequently asked questions (FAQs), hierarchical voice mail menus and, for those agents so equipped, videos and/or web-based information sites delivering to cell phones or PDAs or other modern wireless communication devices are prepared and posted to job database 301 to provide training aids to agents (block 514). This training on how the agents should collect observations across a wide variety of assigned situations is accessed entirely from the agents' cell phones. Also, job location support information (block 513) is posted to include such guides as voice-guided directions utilizing the agents GPS-equipped cell phones and MapQuest® or equivalent services on how to get to the specific locations for the jobs.

The agent job assignments are posted (block 515) in the job database 301 and automatically broadcast or otherwise transmitted to the agents' cell phones (block 516) via the wireless network 110 to the array of assigned agents.

The actual steps an agent follows in a typical job are exemplified in the flowchart shown in FIG. 6. The agent logs on to the cell phone, or responds to the message broadcast in the previous example and a job assignment is presented with details (block 601). The agent, using the cell phone, accesses a voice mail site and receives training (block 602) or reminders of what is desired and how to conduct the task in this assignment. Video or web access on a wireless communication device is also an option for this training. Answers to the agents' questions on how to get to the assignments are also accessed in this step (block 602).

The agent arrives at the first location of a multi-location assignment and uses the cell phone to report (block 603) to the computer server 112 in FIG.4 and then logs in (block 604) and uploads the agent's identification number, the time and the location from his/her GPS or other location information used by cell phone 102.

The agent gathering step (block 605) requires human-observable capabilities, visual and auditory senses and the entry of data via key strokes on the cell phone, or, alternatively, voice commands to be translated by the computer server into data through voice-recognition technology. In addition to observation, photos might be taken of a scene if specified, or perhaps, audio records from a third party person. If requested and if so equipped, the agent might use radio-frequency identification (RFID) or barcode scanners to capture information as well. In some cases, photos will be used to capture information for subsequent pattern recognition. Data and observations are then uploaded to the job database 301 (block 606) and, immediately reviewed for acceptance against the standards of the job (block 607).

These data from this agent and all other agents collected within the time and location parameters are integrated (block 608) and placed in the job database 301. Inasmuch as the agents are usually not professionally trained, the data from any one set of observations are analyzed in the software 300 for the position relative to a normal, or Gaussian-type distribution of all such data collected by other agents in the assignment, or other criteria previously set, in order to eliminate outliers caused by errors in data observation or mistakes in uploading to the computer server. After such auto-inspection, other data derived from other sources such as temperature, prices of commodities, rate of traffic, and similar non-observed information, may be combined (block 609) automatically in computer server 112 to aid in the contracted objectives of the client.

Automatic analysis programs are then applied using, for example, standard data mining programs such as ModelMAX® from ASA® or statistical analyses or relational database analyses such as dbSnap2® which uses data from Oracle® databases, perhaps stored in an Oracle client job database 301. A report is auto-generated (block 610) using report generator 401 (FIG. 4) employing for example, XML-coded data and programs such as BFO® to produce PDF documents for Internet-based viewing or downloading by the client 116. If the data is map-intensive, ArcView® may be used for the report generation. The reports may be with and without the above ancillary data, and uploaded to the client job database 301. The client views the report (block 611) and its changes from time-to time, thus closing the loop that started from the client-requested assignment.

As discussed in detail above, all aspects of the process of the present invention are automated from the collection, quality control of data verification, field assignments, and recruiting and managing field data agents to data analysis, client interactions, billing, report generation, and organizing the agent/computer network. Consequently, the major benefit of the process of the present invention is the productivity, which is another word for lower cost. This automated agent network opens a new genre of market research. Human-observable data surveys can be ordered online, customizable by the users to their specific needs and delivered promptly or on a regular basis so that on-demand survey research can be delivered as a commercial utility. Among the technologies and trends that make these improvements possible are one or more of the following: high-bandwidth, pervasive wireless data networks; mobile phone technology; mobile phones equipped with GPS or other Enhanced 911 location; mobile phones equipped with cameras; image-recognition software for auto-interpretation of objects and alphanumerics; networks with voice menus; voice-synthesis; voice recognition; applications downloadable by mobile phone users; RFID and bar-code scanners; other wireless electronic signal couplers; the Internet; database of GPS locations by street or organization name; low-priced mobile phones PDA-equipped phones; and a culture of persons accustomed to using mobile phones for everyday use.

The following is an example of the use of the system and process of the present invention. Agent 100 using her mobile phone 102 dials in to central server 112 and listens to her voicemail to receive her data collecting assignment for the day. She is given the names and addresses of five markets, three convenience stores and six large chain supermarkets. She drives to the first location and places a call from mobile phone 102 by using one of the pre-assigned keys, thereby sending a message containing the time, date and GPS location of her position using GPS 104. After disconnecting from the system, she enters a store and records the price and brands and categories of a list of assigned products using a barcode or RFID scanner. After gathering the data, she places a call on phone 102 by pushing the pre-assigned button and enters a combination of words or voice commands to enter observed data and, as necessary, key pad numbers representing the information sought. While, she is still connected to server 112, she proceeds down the aisle in this store and snaps a picture of a specialized merchandising display and speaks into phone 102. If there is no mobile service in the store, she accesses her voicemail memo box to save the data to be forwarded to server 112 at a later time. When finished with her assignment in this store location, she enters a code. Initiated by her end-of-sample code, the mobile phone transmits the location of this phone automatically to confirm her assignment location and the date and time stamp. Using assigned codes and numbers, she reports the weather conditions, traffic conditions, number of vehicles in the parking lot, and other information that are relevant to the client 116 specified survey by entering a numerical key strokes on phone 102. She proceeds to the next location and repeats the run to the same stores two days later for the next 4 weeks, unless instructions received on her voicemail change her assignments.

While human-observed data collection is a central theme to the mode of data sampling in this invention, such data collection is not meant to be restricted to using the agent's eyes, ears and sense of touch, nor even the use of the brain. The agent can enhance his/her abilities to collect data by employing other wireless communications or data-collecting devices or technology. Therefore, another embodiment of this invention is to utilize auxiliary devices to aid in the data sampling or collection of information. Such devices include the use of another cell phone handed off to another individual who uses the phone to observe and re-send the data, thus collected, to the agent's cell phone. In this case, the agent acts as a team captain with subordinates assisting the agent in the tasks. One such task is having a participant in a clinical trial use it to report symptoms. Another task is having a sub-agent, less-skilled, use it for low-intensity, fixed-location data sampling such as watching a TV or reading newspapers for specific items to be reported to the agent. In one way or another, the agent can use a wireless communication device to collect data even when the wireless device is not always in his/her hands.

Still another embodiment of this invention, is the use of a wireless communication device such as a cell phone, or a low-cost, limited functionality, disposable wireless communication device, being placed in a fixed location, such as a tree, telephone pole or building. The agent would call the device to monitor sounds of traffic or take pictures of traffic or the number of cars in a parking lot. The agent may initiate the calls or have the device programmed to observe and send at regular intervals and either re-transmit to the agent or other destination. The use of this webcam-type of device or transmitting security camera is primarily to assist and be part of the overall network of agents to collect data programmed by a client for reporting and integrating, not for passive security. Still another application of the same embodiment is to use the wireless communication device to monitor a RFID or Bluetooth device placed in a shipping container or product to collect inventory movement, warehouse shipments or other such commercial application. It may also be useful to monitor location by calling the device, placed with all parties in cooperation, as a small, inexpensive means of tracking shipments or objects as an long-range, enhanced RFID application.

Another embodiment of this invention is the use of the deployed agents to collect data, where the effective client 116 in FIG. 4 is the public. Agents would collect daily or frequently on a specified list of commonly-used everyday consumable products such as bread, milk, toilet paper, and the like, perhaps 50 items in all. Prices for all of these items would be the target data for these agents in a number of retail stores, country-wide, for example, in urban centers with populations of 75,000 or more. The results would be collected and prepared for analysis and reporting by the software 300 in FIG. 4. The results, searchable by zip code are, would be posted on a public website on the Internet. Consumers would download a simple application with the consumable list to be modified somewhat by the consumer according to the consumer's preferences. The consumer would then access the Internet through a browser, check from the list items needed that day or week, just before shopping. They would then specify how far they are willing to drive, how many stores or stops and their desired maximum total driving time. The website would then display the cost of items checked, the cost of gasoline, the minimum and maximum savings as a function of stops, time and distance traveled and optimized driving instructions for each set of conditions, with a map. For commercial reasons, the website would allow advertisements and a link to the advertisements for the specific product categories, savings coupons that could be downloaded and printed and the extra savings if said coupons are incorporated in the total savings previously specified.

Without departing from the spirit and scope of this invention, one of ordinary skill in the art can make various changes and modifications to-the embodiments, of the present invention to adapt it to various usages and conditions. Such changes and modifications are properly, equitably, and intended to be, within the full range of equivalents of the following claims.

What is claimed is:

1. A system for collecting data from a plurality of agents and disseminating the data as information to a client comprising:
(a) a computer server having software for accepting requests received via Internet browser-based interfaces from the client to collect the data generated by data-collecting agents and for receiving the data from the agents at a remote source;
(b) at least one wireless communication device interfaced to the computer server for each of the plurality of agents for downloading instructions to carry out the client's request and for uploading the collected data to the computer server; and
(c) operating means for analyzing, and converting the data received from each of the agents by the server into information for disseminating to the client.

2. The system of claim 1, wherein an agent database and a client request database in the server are used for assigning the client's request to each of the agents.

3. The system of claim 2, wherein the client request database receives input from the client for specifications of the client's request.

4. The system of claim 3, wherein the server software matches information in the agent database with the information in the client request database to determine the agents to be assigned to carry out the client's request.

5. The system of claim 4, wherein the server software prepares the instructions for each of the assigned agents on the details for collecting the data based on the client's request.

6. The system of claim 5, wherein the instructions for the agents are translated by the server software into the tasks to be carried out by the agents including observation parameters of the density, frequency and location of observations.

7. The system of claim 1, wherein the wireless communication device is equipped with positioning means for determining the location of the device.

8. The system of claim 7, wherein the wireless communication device is, also equipped with data collecting means selected from the group consisting of image data collector, audio data collector, keypad for stylus-entered data, barcode scanner, radio frequency identification (RFID) scanner, other wireless electronic signal coupler, and combinations thereof.

9. The system of claim 1, wherein the server software facilitates payment to the agents for services rendered in connection with the data collection.

10. The system of claim 1, wherein the information is disseminated to the client via the Internet.

11. A method for collecting data from a plurality of agents and disseminating the data as information to a client comprising:
(a) receiving from the client via Internet browser-based computer server interfaces a request to collect the data generated by the data-collecting agents;
(b) downloading instructions to carry out the client's request by each of the agents via at least one wireless communication device interfaced to the computer server;
(c) uploading the data collected by each of the agents via the wireless communication device to the computer server; and
(d) analyzing and converting the data received from the agents by the server into information for disseminating to the client.

12. The method of claim 11, wherein the agents are assigned to carry out the client's request from an agent database and a client request database.

13. The method of claim 12, wherein the client inputs specifications of the client's request.

14. The method of claim 13, wherein the information in the agent database is matched with the information in the client request database to determine the agents to be assigned to carry out the client's request.

15. The method of claim 14, wherein the instructions for each of the assigned agents are prepared on the details for collecting the data based on the client's request.

16. The method of claim 15, wherein each of the assigned agents download from the server the instructions that have been translated into the tasks to be carried out by the agents including observation parameters of the density, frequency and location of observations.

17. The method of claim 11, wherein at least one of the agents' wireless communication devices has positioning means for determining the location of the device.

18. The method of claim 11, wherein each of the agents collect data using data collecting means selected from the group consisting of image data collector, audio data collector, keypad for stylus-entered data, barcode scanner, radio frequency identification (RFID) scanner, other wireless electronic signal coupler, and combinations thereof.

19. The method of claim 11, wherein the client receives via the Internet a report of the information based on the data collected by the agents.

20. A system for collecting human-observable data from a plurality of agents and disseminating the data as information to a client comprising:
(a) a computer server having software for accepting requests received via Internet browser-based interfaces from the client to collect the data generated by data-collecting agents and for receiving the data from the agent at a remote source;
(b) an agent database within the computer server;
(c) a client request database within the computer server, the server software for also matching information in the agent database with the information in the client request database to determine the agents to be assigned to carry out the client's request and preparing the instructions for each of the assigned agents on the details for collecting the data based on the client's request;
(d) at least one mobile phone equipped with a global poisoning system interfaced to the computer server for each of the plurality of agents for downloading instructions to carry out the client's request and for uploading the collected data to the computer server, said mobile phone is also equipped with data collecting means selected from the group consisting of image data collector, audio data collector, keypad for stylus-entered data, barcode scanner, radio frequency identification (RFID) scanner, other wireless electronic signal coupler, and combinations thereof for electronically-transmitted the data by the agent into the phone from a source near the agent, and subsequently translated into digital alphanumeric characters; and
(e) operating system within the computer server having system software for analyzing, and converting the data received from the agent by the server into information for disseminating to the client via the Internet.

21. The system for collecting data from a plurality of agents for a user comprising:
(a) a computer server operated by the user having software to collect the data generated by data-collecting agents and for receiving the data from the agents at a remote source:
(b) at least one wireless communication device interfaced to the computer server for each of the plurality of agents for downloading instructions to carry out the user's request and for uploading the collected data to the computer server; and
(c) operating means for analyzing, and converting the data received from each of the agents by the server into information for disseminating to the user.

22. A method for collecting data from a plurality of agents comprising:
(a) transforming data specifications into specific instructions for each of the plurality of agents to satisfy said data collection specifications;
(b) downloading the instructions to carry out the data collection by each of the agents via at least one wireless communication device interfaced to the computer server;
(c) uploading the data collected by each of the agents via the wireless communication device to the computer server; and
(d) analyzing and converting the data received from the agents by the server into information for disseminating to the user.
